(19) United States
(12) Patent Application Publication
(10) Pub. No.: US 2009/0279040 A1
(43) Pub. Date: Nov. 12, 2009

(54) Liquid Crystal Panel Structure and Method for Manufacturing the Same

(75) Inventors: Chih-Wei Chu, Hsinchu (TW); Shih-Yu Wang, Hsinchu (TW); Ming-Che Hsieh, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 12/243,573

(22) Filed: Oct. 1, 2008

(30) Foreign Application Priority Data
May 8, 2008 (TW) 97116978

(51) Int. Cl. G02F 1/1339; G02F 1/13

(52) U.S. Cl. 349/155; 349/187

(57) ABSTRACT

A liquid crystal panel structure and a method for manufacturing the same are disclosed. The liquid crystal panel structure comprises a first substrate, a second substrate, a plurality of ball spacers, and a positioning structure. The second substrate is assembled parallel to the first substrate, and a gap is formed therebetween. The ball spacers are disposed in the gap to space the first substrate and the second substrate. The positioning structure is formed on one of the substrates and has a side collecting portion such that the ball spacers are moved to be located therein. The method for manufacturing the liquid crystal panel structure is to drop a solution which contains the ball spacers on the first substrate or the second substrate. Then, the ball spacers are positioned in the positioning structure after the solution is vaporized and a proper gap between the first and the second substrate is formed accordingly after assembly.

This application claims priority to Taiwan Patent Application No. 097116978 filed on May 8, 2008, the disclosures of which are incorporated herein by reference in their entirety.

### CROSS-REFERENCES TO RELATED APPLICATIONS

Not applicable.

### BACKGROUND OF THE INVENTION

1. Field of the Invention

The present invention provides a display panel structure and a method for manufacturing the same. In particular, the present invention provides a liquid crystal panel structure capable of precisely positioning a plurality of ball spacers therein and a method for manufacturing the same.

2. Descriptions of the Related Art

With the rapid development of liquid crystal display (LCD) technologies, LCDs are evolving towards light weight and miniaturized profiles. To cater for this tendency while still achieving a high image displaying quality, the structural design and manufacturing process control have become concerns of great importance for the LCDs. For example, in LCDs that are currently available, a plurality of ball spacers are used to control the spacing between an upper and lower substrate. Unfortunately, the precise positioning of the ball spacers has been a great challenge.

More specifically, in the prior art, ball spacers are formed on the substrate of an LCD through an ink injection process. However, in general, the precision to which the ink drops can be controlled is only as high as 84 micrometers (μm), which is far greater than the finest pitch of about 40 μm between pixel areas in an LCD. Consequently, when ball spacers are formed on a substrate through the ink injection process, it is usually impossible to control the distribution of the ball spacers precisely without having to form the ball spacers at predetermined locations on the substrate. Accordingly, the variation in the height of the surface profile may cause inconsistent spacing between the upper and the lower substrate and consequent degradation of the contrast ratio of the display, thus adversely affecting the image displaying quality.

In view of this, to position the ball spacers more precisely and consequently improve the contrast ratio of images displayed, it is important to improve the liquid crystal display panel structure of the prior art and a manufacturing method thereof.

### SUMMARY OF THE INVENTION

One objective of this invention is to provide a liquid crystal panel structure, which comprises a first substrate, a second substrate, a plurality of ball spacers and a positioning structure. The first substrate and the second substrate are disposed parallel to each other with a gap formed therebetween. The plurality of ball spacers is disposed in the gap to space the first substrate and the second substrate apart. The positioning structure is formed on one of the first substrate and the second substrate, and has a side collecting portion such that the ball spacers are at least partially located in the side collecting portion.

Another objective of this invention is to provide a method for manufacturing a liquid crystal panel structure, comprising the following steps: providing a first substrate and a second substrate; forming a positioning structure with a side collecting portion on one of the first substrate and the second substrate; dropping a solution to cover the positioning structure, wherein the solution contains a plurality of ball spacers; removing the solution to gather at least one portion of the ball spacers in the side collecting portion of the positioning structure; assembling the first substrate and the second substrate, wherein a gap is formed by the ball spacers disposed between the first substrate and the second substrate.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a liquid crystal panel structure according to the first embodiment of this invention;

FIGS. 2A to 2E are top views of several examples of a positioning structure of this invention;

FIG. 3 is a schematic view of a liquid crystal panel structure according to the second embodiment of this invention;

FIG. 4 is a schematic view of a liquid crystal panel structure according to the third embodiment of this invention;

FIG. 5 is a schematic view of a liquid crystal panel structure according to the fourth embodiment of this invention;

FIG. 6 is a schematic view of a liquid crystal panel structure according to the fifth embodiment of this invention;

FIG. 7 is a schematic view of a liquid crystal panel structure according to the sixth embodiment of this invention;

FIG. 8 is a schematic view of a liquid crystal panel structure according to the seventh embodiment of this invention;

FIG. 9A is a schematic view illustrating the status before the ball spacers is positioned by the positioning structure;

FIG. 9B is a schematic view illustrating a status when the ball spacers are being positioned; and

FIG. 9C is a schematic view illustrating a status after the ball spacers have been positioned by the positioning structure.

### DESCRIPTION OF THE PREFERRED EMBODIMENT

In the following description, this invention will be explained with reference to embodiments thereof. However, profiles and dimensions illustrated in these embodiments and the attached drawings are only intended to explain this invention, rather than to limit this invention to any specific environment, applications or particular implementations described in these embodiments.

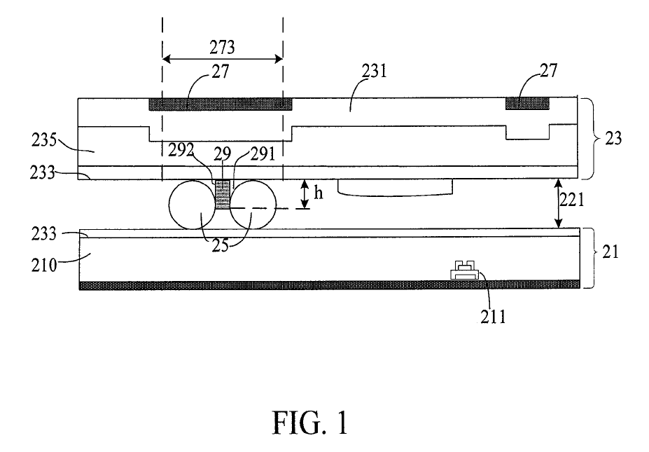

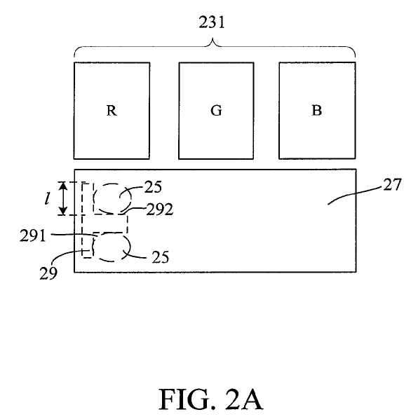

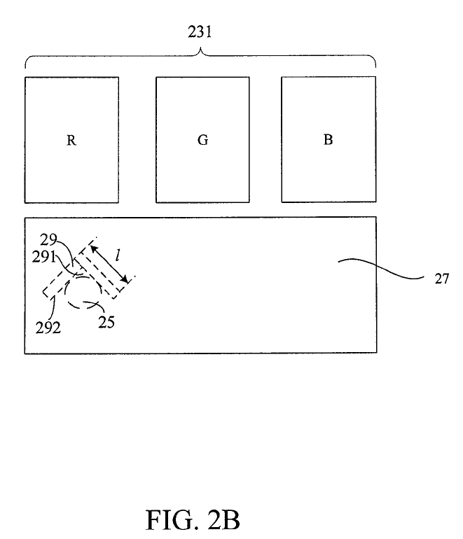

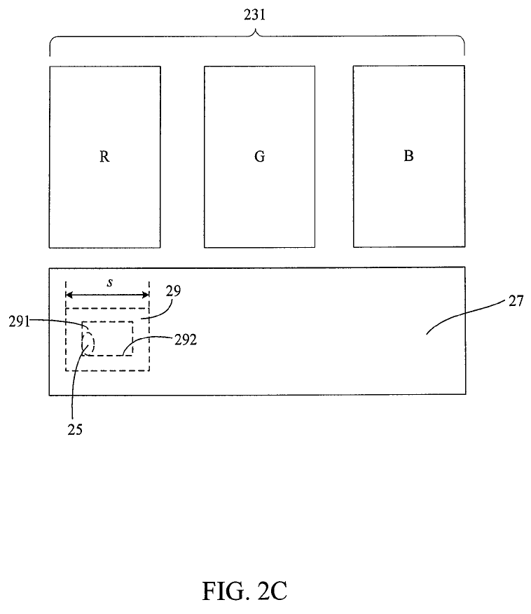

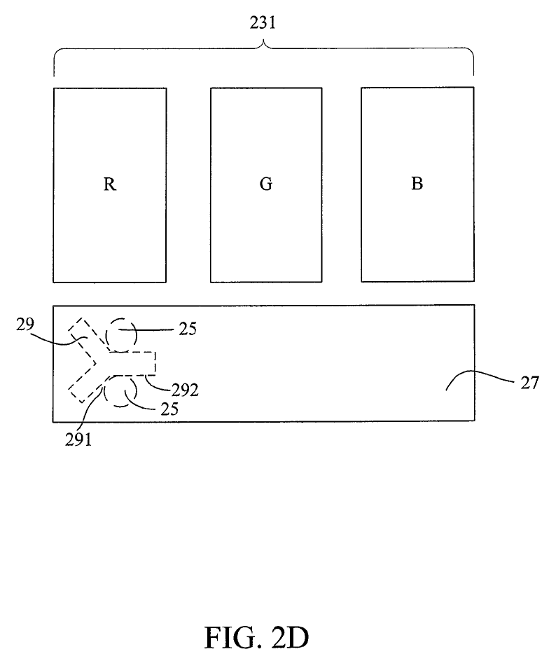

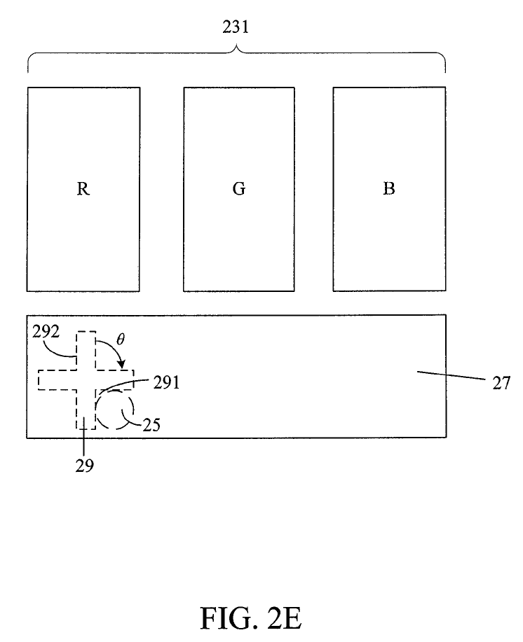

FIG. 1 and FIG. 2A illustrate schematic views of a liquid crystal panel structure according to the first embodiment of this invention are depicted therein. The liquid crystal panel structure of this invention primarily comprises a first substrate 21, a second substrate 23, a plurality of ball spacers 25, a light-shielding portion 27 and a positioning structure 29. In this embodiment, the first substrate 21 may be a thin film transistor (TFT) substrate formed with a TFT array 211 and a passivation layer 210 thereon. The passivation layer 210 has a conductive layer (e.g., an Indium Tin Oxide (ITO) layer 233) formed thereon. The passivation layer 210 is adapted to protect the TFT array 211 and planarize a surface of the TFT array 211. Furthermore, the second substrate 23 may be a color filter substrate, which has also a conductive layer (e.g., an ITO layer 233) formed on the surface thereof as well as a pixel array 231 and a light-shielding portion 27 disposed therein. Interposed between the ITO layer 233 and the pixel array 231 is a passivation layer 235, which may be a planarization layer or an over coating (OC) layer for planarizing a surface of the pixel array 231. The pixel array 231 with a schematic size is located in display blocks, and comprises such as red pixels, green pixels and blue pixels. The light-shielding portion 27 may be a black matrix, while the pixel array 231 and the black matrix are interlaced with each other on the second substrate 23. The positioning structure 29 should be disposed correspondingly to a non-transparent region (i.e., the light-shielding portion 27) between the display blocks. More specifically, the positioning structure 29 and the light-shielding portion 27 are at least partially overlapped with each other to form a shielding area 273 for masking the positioning structure 29 and adjacent areas, so that at least a portion or all of the ball spacers 25 can be located in the shielding area 273. Thus, the degradation of the contrast ratio of the image may be improved by forming the ball spacers 25 inside the light-shielding portion 27.

As described above, the first substrate 21 and the second substrate 23 are substantially parallel to each other with a gap 221 defined therebetween. The gap 221 is formed by disposing the ball spacers 25 between the two substrates 21, 23. The ball spacers 25 is configured to space the two substrates 21, 23 apart to provide a space necessary for subsequent filling of a liquid crystal material. This embodiment is unique because the positioning structure 29 is formed on the second substrate 23 to position a plurality of ball spacers 25 into predetermined positions between the two substrates 21, 23; i.e., at least a portion or all of the ball spacers 25 are positioned by the positioning structure 29, so that an adequately uniform gap 221 is maintained between the two substrates 21, 23 to improve the image displaying quality.

In particular, the positioning structure 29 of this embodiment is a protrusion or a bump protruding from the ITO layer 233 of the second substrate 21 into the gap 221. Furthermore, the positioning structure 29 has a side collecting portion 291. The side collecting portion 291 primarily helps to collect the ball spacers 25 in such a way that the spacers 25 can be positioned by the positioning structure 29 precisely to prevent the ball spacers from being positioned at non-predetermined locations (i.e., outside the light-shielding portion 27) due to poor positioning precision and consequently causing the degradation of the contrast ratio. More specifically, the side collecting portion 291 is defined by at least one sidewall 292. The shape of the bump may be selected from an L-shape, a rectangle, a four-corner loop, a T-shape, a cross, a V-shape, and a combination thereof, although it is not merely limited thereto. The aforesaid bump shapes are defined by the sidewall 292 of the side collecting portion 291. FIGS. 2A to 2E are top views of a plurality of examples of the positioning structure 29 of this invention. However, what is depicted therein is only for purpose of illustration, and the dimensional scales of the elements are not intended to limit this invention. The structures drawn by the dashed lines in these figures denote the positioning structure 29. It should be further appreciated that the L-shape positioning structure 29 shown in FIG. 2B and the V-shape positioning structure 29 shown in FIG. 2D both have an included angle θ substantially ranging from 40° to 135°, and even further, an included angle θ of substantially 90° (i.e., the positioning structure 29 is a rectangle, a T-shape or a cross) will position the ball spacers 25 correctly.

Next, as shown in FIG. 2A, letters R, G, B labeled therein represent pixel arrays 231 in display blocks on the second substrate 23 respectively, in which the pixel arrays comprise red pixels, green pixels and blue pixels with schematic sizes. Since the positioning structure 29 in the light-shielding portion 27 is T-shaped, during the evaporation process of injected ink drops, at least a portion or all of the ball spacers 25 contained in the ink drops will gather to the sides of the positioning structure 29 under both the surfaces of the sidewall 292 and the surface of the ink drops, thus achieving the objective of precisely positioning the ball spacers 25. Similarly, FIGS. 2B to 2E illustrate the side collecting portions 291, which can be L-shaped, rectangular shaped, V-shaped, cross-shaped and four-corner loop shaped respectively. The functions of which are all similar to the side collecting portion 291 shown in FIG. 2A and thus will not be described again herein.

In the preferred embodiment, as shown in FIGS. 2A to 2B and FIGS. 2D to 2E, the side collecting portion 291 is of an open type, while the shortest side l of the sidewall 292 is preferably substantially greater than an average diameter of the ball spacers 25. For example, the ball spacers 25 have an average diameter of substantially 4 μm, so the shortest side l of the sidewall 292 of the positioning structure 29 is preferably greater than 4 μm in order for the sidewall 292 to position at least a portion of the ball spacers 25. In an alternative embodiment, the side collecting portion 291 shown in FIG. 2C is of a closed type. The shortest side s of the sidewall 292 thereof should be substantially greater than twice the average diameter of the ball spacers 25. Hence, the shortest side s is greater than 8 μm in order for the sidewall 292 to position at least a portion of the ball spacers 25. Additionally, the height h to which the positioning structure 29 protrudes from the substrate is substantially greater than 0.1 μm and less than the spacing between the first substrate 21 and the second substrate 23. More specifically, the height h substantially ranges from 0.1 μm to 6 μm, and preferably is one third of the average diameter of the ball spacers 25 in order for the positioning structure 29 to collect the ball spacers 25.

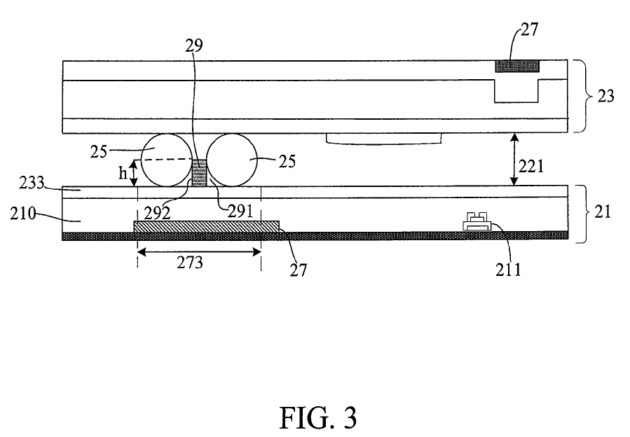

FIG. 3 depicts the second embodiment of this invention, which is a liquid crystal panel structure comprising a first substrate 21, a second substrate 23, a plurality of ball spacers 25, a light-shielding portion 27 and a positioning structure 29. In this embodiment, the liquid crystal panel structure is generally the same as that of the previous embodiment, i.e., the first substrate 21 may be a TFT substrate, while the second substrate 23 may be a color filter substrate. However, unlike the previous embodiment, the positioning structure 29 of this embodiment is a bump disposed on the ITO layer 233 on the surface of the first substrate 21, and is preferably disposed correspondingly to the light-shielding portion 27 of the first substrate 21. More specifically, the positioning structure 29 and the light-shielding portion 27 are at least partially overlapped with each other to form a shielding area 273 for shielding the positioning structure 29 and adjacent areas to space the first and the second substrates 21, 23 apart uniformly. The light-shielding portion 27 of this embodiment may be a metal line, while the TFT array 211 and the metal line are interlaced with each other on the first substrate 21. As in the previous embodiment, the positioning structure 29 of this embodiment also has a side collecting portion 291 defined by the sidewall 292. Its geometry, its function of collecting ball spacers, and its positional relationship with the light-shielding portion 27 are all the same as the previous embodiment, and thus will not be described again herein.

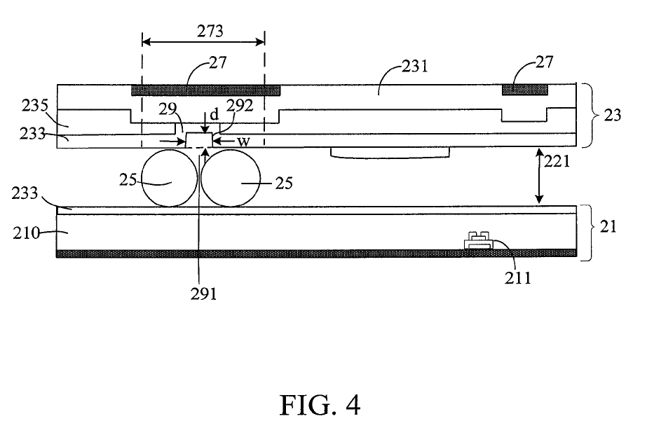

FIG. 4 depicts the third embodiment of this invention, which is a liquid crystal panel structure comprising a first substrate 21, a second substrate 23, a plurality of ball spacers 25, a light-shielding portion 27 and a positioning structure 29. Like the first embodiment, the first substrate 21 in this embodiment may be a TFT substrate, which is formed with a passivation layer 210 for protecting the TFT array 211. Furthermore, the second substrate 23 may be a color filter substrate, which has an ITO layer 233 formed on the surface thereof as well as a pixel array 231 and a light-shielding portion 27 disposed therein. Interposed between the ITO layer 233 and the pixel array 231 is a passivation layer 235 for planarizing the surface of the pixel array 231. The pixel array 231 comprises red pixels, green pixels and blue pixels. The light-shielding portion 27 may be a black matrix, and the pixel array 231 and the black matrix are interlaced with each other on the second substrate 23. The positioning structure 29 should be disposed correspondingly to the light-shielding portion 27. More specifically, the positioning structure 29 and the light-shielding portion 27 are at least partially overlapped with each other to form a shielding area 273 for shielding the positioning structure 29 and adjacent areas, so that at least a portion or all of the ball spacers 25 can be located in the shielding area 273. Thus, the degradation of the contrast ratio of the image may be improved by forming the ball spacers 25 inside the light-shielding portion 27. For detailed structures disposed between the first substrate 21 and the second substrate 23, reference may be made to the first embodiment and no repeated description will be made herein.

Unlike the first embodiment, the positioning structure 29 of this embodiment is a trench, which is formed by removing a portion of the passivation layer 235 to have the ITO layer 233 of the second substrate 23 recessed inwardly or by removing the ITO layer 233 directly. Furthermore, the recessed positioning structure 29 has a side collecting portion 291 defined by the sidewall 292. The side collecting portion 291 has the same geometry, function and corresponding collecting effect as those of the side collecting portion 291 of either the open type or the closed type described in the first embodiment, and also has the capability of collecting the ball spacers 25 into the positioning structure 29 when the ink drops evaporates and thus will not be described again herein.

In the preferred embodiment, the positioning structure 29 has a recessed depth d that is substantially greater than 0.1 μm, which is adapted to have the ball spacers 25 maintain a gap 221. Additionally, to prevent the ball spacers 25 from falling into the positioning structure 29 of this embodiment, the positioning structure 29 should have a width w substantially less than an average diameter of the ball spacers 25. For example, the positioning structure 29 should have a width that is less than 4 μm. As a result, as ink drops in the trench defined by the sidewall 292 evaporate, the ball spacers 25 will be collected to the positioning structure 29.

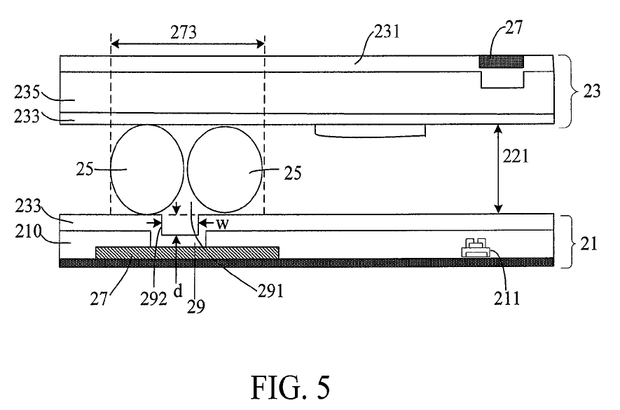

FIG. 5 depicts the fourth embodiment of this invention, which is a liquid crystal panel structure comprising a first substrate 21, a second substrate 23, a plurality of ball spacers 25, a light-shielding portion 27 and a positioning structure 29. The liquid crystal panel structure of this embodiment is generally the same as that of the third embodiment. However, unlike the previous embodiments, the positioning structure 29 of this embodiment is a trench or a recess formed in the first substrate 21. In particular, the positioning structure 29 is disposed correspondingly to the light-shielding portion 27 of the first substrate 21; i.e., the positioning structure 29 and the light-shielding portion 27 are at least partially overlapped with each other to form a shielding area 273 for shielding the positioning structure 29 and adjacent areas, so that at least a portion or all of the ball spacers 25 can be positioned in the shielding area 273 to space the first and the second substrates 21, 23 apart uniformly. The light-shielding portion 27 of this embodiment is a metal line, while the TFT array 211 and the metal line are interlaced with each other on the first substrate 21. It should be noted that the recessed positioning structure 29 is formed by removing a portion of the passivation layer 210 to have the ITO layer 233 of the first substrate 21 recessed inwardly. As in the previous embodiment, the recessed positioning structure 29 of this embodiment also has a side collecting portion 291 defined by the sidewall 292. The geometry of the side collecting portion 291, its function of collecting ball spacers, and its positional relationship with the light-shielding portion 27 are all the same as the previous embodiments, and thus will not be described again herein.

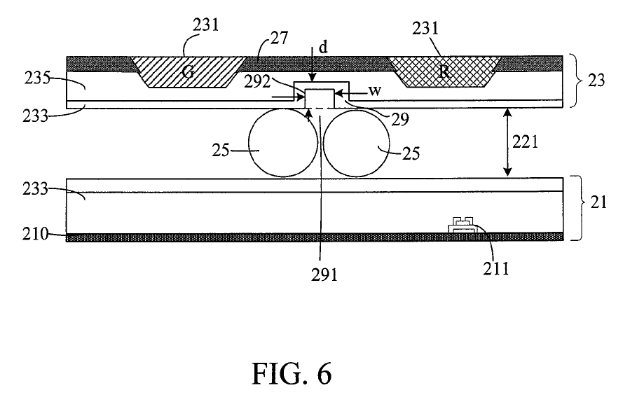

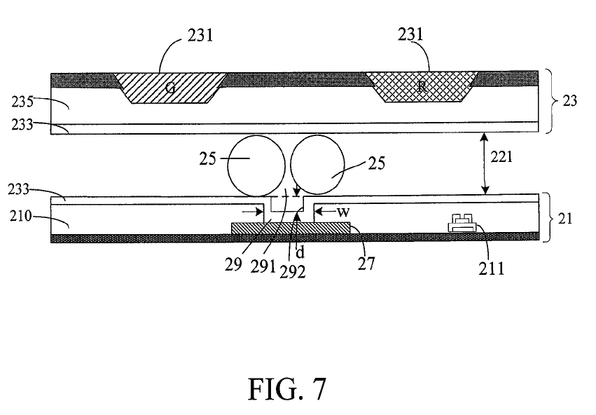

The liquid crystal panel structure of these embodiments of this invention may be applied to various types of liquid crystal panels. For example, the liquid crystal panel structure disclosed in this invention may also be applied to such as a twisted nematic (TN) type LCD product. In particular, FIGS. 6 and 7 respectively depict the fifth and a sixth embodiment of this invention, both of which apply the aforesaid liquid crystal panel structure of this invention to a TN type liquid crystal panel with an organic film. In particular, in the liquid crystal panel structure of the fifth embodiment, the positioning structure 29 is formed by removing a portion of the passivation layer 235 corresponding to the black matrix to have the ITO layer 233 of the second substrate 23 recessed inwardly. In contrast, in the liquid crystal panel structure of the sixth embodiment, the positioning structure 29 is formed by removing a portion of the passivation layer 210 corresponding to the metal line to have the ITO layer 233 of the first substrate 21 recessed inwardly. Basically, structures, functions and effects of the elements in the liquid crystal panel structure of the two embodiments are the same as those of the previous embodiments and thus will not be described again herein.

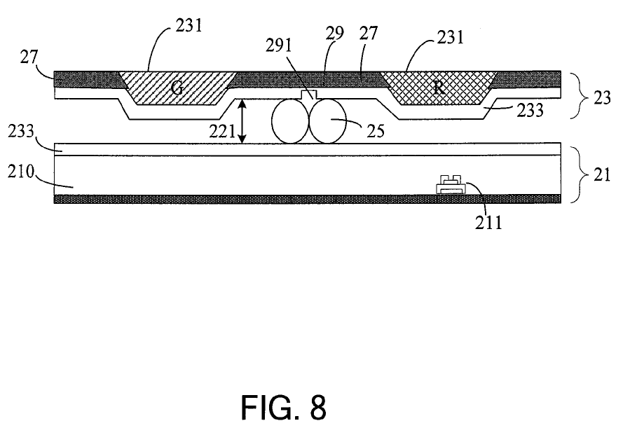

Unlike the previous embodiments, the recessed positioning structure 29 of this embodiment is formed primarily by removing the ITO layer 233 between the pixel arrays 231 in the second substrate 23, as depicted in FIG. 8. The ITO layer 233 and the light-shielding portion (i.e., the black matrix) 27 have different surface energies, so ink drops injected onto the black matrix to form a small contact angle and during the heating process for evaporating the ink drops, the ball spacers 25 can be collected into the positioning structure 29 precisely, thus achieving an improved contrast ratio and decreased light leakage. Similarly, the positioning structure 29 may also be formed by removing the ITO layer 233 of the first substrate 21 (not shown).

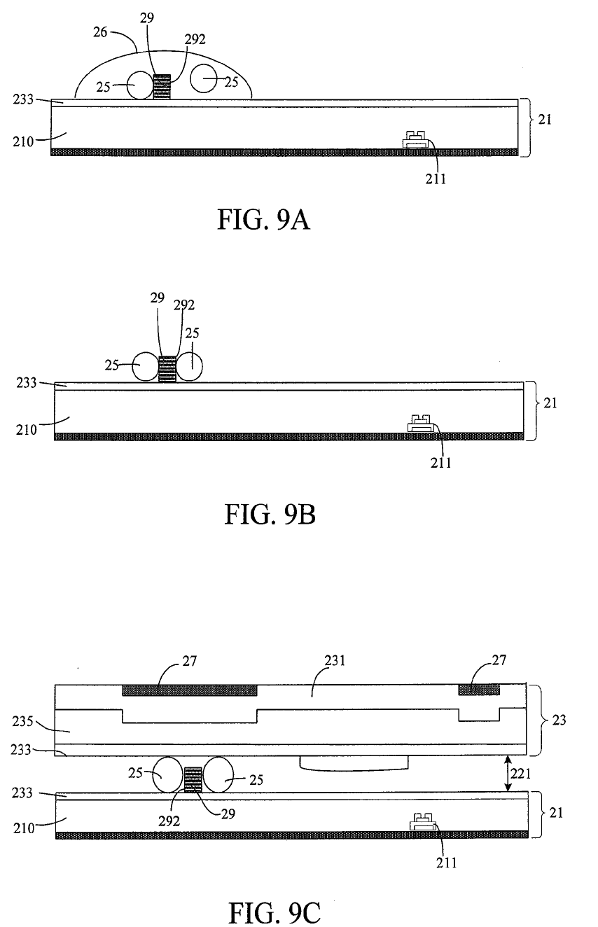

This invention further provides a method for manufacturing a liquid crystal panel structure, which is adapted to manufacture liquid crystal panel structures of the various embodiments described above. Particularly, this method is adapted to precisely collect a plurality of ball spacers between the upper and lower substrate in a liquid crystal panel structure. This method will be detailed as follows with reference to FIGS. 9A to 9C. It should be appreciated that the structural features, functions and relationships among the elements set forth in this method, reference may be made to the above description, so the detailed description of technical features the elements will be omitted from the following description. The method for manufacturing a liquid crystal panel structure of this invention comprises the following steps.

In step (a), a first substrate 21 and a second substrate 23 is formed. The first substrate 21 may be a TFT substrate, while the second substrate 23 may be a color filter substrate.

In step (b), a positioning structure 29 is formed, including a side collecting portion 291 on one of the first and the second substrates 21, 23. Preferably, the positioning structure 29 is formed within a light-shielding portion 27 on one of the first and the second substrates 21, 23. FIG. 9A illustrates a positioning structure 29 that has been formed on the first substrate 21. Additionally, by forming the positioning structure 29 on one of the bump and the trench described above, the side collecting portion 291 can be L-shaped, rectangle, four-corner looped, T-shaped, cross-shaped, V-shaped, and the combinations thereof.

In step (c), drop a solution 26 to cover the positioning structure 29. Each drop of the solution 26 contains a plurality of ball spacers 25, and a radius of each drop is preferably less than 40 μm. In particular, in step (c), drops of the solution 26 are formed above the positioning structure 29 through an ink injecting process to cover the positioning structure 29.

In step (d), the solvent in the solution 26 is removed, to gather at least a portion of the ball spacers 25 into the side collecting portion 291 of the positioning structure 29, as shown in FIG. 9B. In particular, a heating process may be used in step (d) to remove the solvent through evaporation. During the evaporation of the solvent, at least a portion of the ball spacers 25 will gather to the side collecting portion 291 of the positioning structure 29 under the surface energy action of both the surface of the sidewall 292 of the side collecting portion 291 and the surface of the ink drops, thus precisely positioning the ball spacers 25.

In step (e), the second substrate 23 is assembled onto the first substrate 21 with a uniform gap 221. The gap 221 is formed between the first and the second substrate 21, 23 because of the uniformly distributed ball spacers 25.

In summary, this invention provides a liquid crystal panel structure and a method for manufacturing the same. On one hand, the ball spacers can be positioned more precisely within the non-transparent light-shielding portions such as the black matrix or the metal line, thereby to space the color filter layer and the TFT substrate apart uniformly and decrease variation of the spacing between the two substrates. On the other hand, this may mitigate light leakage of the liquid crystal panel, and thus increase the contrast ratio.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A liquid crystal panel structure, comprising
a first substrate;
a second substrate, disposed parallel to the first substrate, wherein the first substrate and the second substrate form with a gap therebetween;
a plurality of ball spacers, disposed in the gap to space the first substrate and the second substrate; and
a positioning structure, formed on one of the first substrate and the second substrate, wherein the positioning structure has a side collecting portion such that the ball spacers are at least partially located in the side collecting portion.

2. The liquid crystal panel structure as claimed in claim 1, further comprising a light-shielding portion formed on one of the first substrate and the second substrate.

3. The liquid crystal panel structure as claimed in claim 2, wherein the first substrate has a thin-film-transistor array, the light-shielding portion is a metal line, and the metal line and the thin-film-transistor array are interlaced with each other on the first substrate.

4. The liquid crystal panel structure as claimed in claim 2, wherein the second substrate has a pixel array, the light-shielding portion is a black matrix, and the pixel array and the black matrix are interlaced with each other on the second substrate.

5. The liquid crystal panel structure as claimed in claim 2, wherein the positioning structure is overlapped with at least one portion of the light-shielding portion, and at least one portion of the ball spacers is disposed in the light-shielding portion.

6. The liquid crystal panel structure as claimed in claim 5, wherein all of the ball spacers are substantially disposed in the light-shielding portion.

7. The liquid crystal panel structure as claimed in claim 1, wherein the positioning structure comprises a bump, protruding into the gap from one of the substrates.

8. The liquid crystal panel structure as claimed in claim 7, wherein a shape of the bump is selected from one of an L-shape, a rectangle, a four-corner loop, a T-shape, a cross, a V-shape and a combination thereof.

9. The liquid crystal panel structure as claimed in claim 7, wherein the side collecting portion is defined by at least one sidewall.

10. The liquid crystal panel structure as claimed in claim 9, wherein the sidewall has at least one included angle substantially between 40 degrees and 135 degrees.

11. The liquid crystal panel structure as claimed in claim 7, wherein the shortest side of the bump is substantially greater than an average diameter of the ball spacers.

12. The liquid crystal panel structure as claimed in claim 7, wherein a height of the bump is substantially greater than 0.1 micrometers and is smaller than a distance between the first substrate and the second substrate.

13. The liquid crystal panel structure as claimed in claim 1, wherein the positioning structure is a trench, and the trench is formed on one of the substrates.

14. The liquid crystal panel structure as claimed in claim 13, wherein a shape of the trench is selected from one of an L-shape, a rectangle, a four-corner loop, a T-shape, a cross, a V-shape and a combination thereof.

15. The liquid crystal panel structure as claimed in claim 13, wherein the side collecting portion is defined by at least one sidewall.

16. The liquid crystal panel structure as claimed in claim 15, wherein the sidewall has at least one included angle substantially between 40 degrees and 135 degrees.

17. The liquid crystal panel structure as claimed in claim 13, wherein the shortest side of the trench is substantially greater than an average diameter of the ball spacers.

18. The liquid crystal panel structure as claimed in claim 13, wherein a depth of the trench is substantially greater than 0.1 micrometers.

19. The liquid crystal panel structure as claimed in claim 13, wherein a width of the trench is substantially less than an average diameter of the ball spacers.

20. A method for manufacturing a liquid crystal panel structure, the method comprising the steps of:
(a) providing a first substrate;
(b) forming a side collecting portion, including a positioning structure on the first substrate;
(c) dropping a solution to cover the positioning structure, wherein the solution contains a plurality of ball spacers;
(d) removing the solution to gather at least one portion of the ball spacers in the side collecting portion of the positioning structure;
(e) assembling a second substrate on the first substrate, wherein a gap is formed by the ball spacers disposed between the first substrate and the second substrate.

21. The method as claimed in claim 20, wherein the step (b) is to form the positioning structure within a light-shielding portion on one of the first substrate and the second substrate.

22. The method as claimed in claim 20, wherein the step (b) comprises a step of forming a shape of the positioning structure which is selected from one of an L-shape, a rectangle, a four-corner loop, a T-shape, a cross, a V-shape and a combination thereof.

23. The method as claimed in claim 20, wherein the step (b) comprises a step of forming a bump as the positioning structure.

24. The method as claimed in claim 20, wherein the step (b) comprises a step of forming a trench as the positioning structure.

25. The method as claimed in claim 20, wherein the step (b) comprises a step of defining the side collecting portion by at least one sidewall.

26. The method as claimed in claim 25, wherein the at least one sidewall having an included angle substantially between 40 degrees and 135 degrees.
